(19) United States
(12) Patent Application Publication
(10) Pub. No.: US 2015/0043520 A1
(43) Pub. Date: Feb. 12, 2015

(54) Methods and Apparatuses for Provision of Reference Signal Design for Downlink Tracking in Occupied Shared Band

(71) Applicants: Pengfei Sun, Beijing (CN); Na Wei, Beijing (CN); Wei Bai, Beijing (CN); Haiming Wang, Beijing (CN)

(72) Inventors: Pengfei Sun, Beijing (CN); Na Wei, Beijing (CN); Wei Bai, Beijing (CN); Haiming Wang, Beijing (CN)

(73) Assignee: Broadcom Corporation, Irvine, CA (US)

(21) Appl. No.: 14/357,876

(22) PCT Filed: Nov. 17, 2011
(86) PCT No.: PCT/CN2011/082361

§ 371 Date: May 13, 2014

(51) Int. Cl. H04W 72/04; H04W 56/00; H04L 5/00

(52) U.S. Cl. CPC H04W 72/0453; H04L 5/005; H04W 56/003
USPC 370/330

(57) ABSTRACT

A method, apparatus and computer program product are provided for generating Reference Signals utilized in downlink tracking of an unlicensed band. A method and apparatus may determine whether carriers of an unlicensed band secondary component carrier are available for usage to provide a signal(s), enabling timing and frequency tracking of downlink carriers responsive to discontinuous transmission via a medium(s) of the unlicensed band utilized to provide content to devices. The method and apparatus may also select the signal based on a band of the carriers and a detection indicating whether communication terminals of a coexisting system are using a carrier of the band. The method and apparatus may provide the signal to a device(s) via a carrier responsive to determining that the carrier is available or via an occupied carrier utilized by the coexisting system enabling the device to continue tracking of timing and frequency information of the downlink carriers.

### TECHNOLOGICAL FIELD

Embodiments of the present invention relate generally to wireless communication technology and, more particularly, to a method, apparatus and computer program product for providing configurable reference signals for downlink tracking in an unlicensed band of a communications system.

### BACKGROUND

Mobile terminals routinely communicate within a licensed spectrum via networks supervised by various cellular operators. The licensed spectrum, however, has a finite capacity and may become somewhat scarce as the number of mobile terminals that are configured to communicate within the licensed spectrum increases at fairly dramatic rates. As the demands placed upon the licensed spectrum by the various mobile terminals begin to saturate the licensed spectrum, the mobile terminals may experience increasing levels of interference or limited resources with the licensed spectrum potentially eventually becoming a bottleneck for such communications. Therefore, it may be necessary to enable cellular operations on license exempt bands as well as in suitable instances to help offload the traffic, improve the peak data rate, and improve the spectrum efficiency.

An increasing number of other network topologies are being integrated with cellular networks. However, there may already be some other network system or other cellular operations operating on an unlicensed band. These other network topologies include, for example, wireless fidelity (WiFi) networks, ad hoc networks and various other local area networks. The terminals, either mobile or fixed, supported by these other network topologies may communicate with one another in an unlicensed spectrum, such as a licensed-exempt industrial scientific medical (ISM) radio band. The ISM radio band supports other non-cellular systems, such as WiFi systems operating in accordance with the Institute of Electrical and Electronics Engineers (IEEE) 802.11 standard, ZigBee systems operating in accordance with the IEEE 802.15 standard, Bluetooth systems and universal serial bus (USB) wireless systems. In this regard, the ISM radio band may include the 2.4 GHz ISM band in which WiFi 802.11b and 802.11g systems operate and the 5 GHz ISM band in which WiFi 802.11a systems operate. Though cellular technologies have not generally been deployed in the ISM band, such deployment could be considered for local-area Long Term Evolution (LTE) cellular networks as long as they meet the regulatory requirements in country-specific ISM bands, e.g., Federal Communications Commission (FCC) in the United States. Another example of a license exempt band is TV White Space (TVWS), which has been investigated widely in the recent years due to the large available bandwidths at suitable frequencies (e.g., TV spectrum in the 54-698 MHz range in the U.S.) for different radio applications. In the United States, the FCC has regulated licensed or license-exempt TV bands for the secondary-system applications, e.g., cellular, WiFi, WiMax, etc., on TV Band Devices (TVBD).

In an instance in which an LTE system is deployed in a licensed band, the LTE system is typically designed for continuous transmission, since a corresponding network operator may need to buy a certain spectrum for the network operator's usage. However, in order to deploy an LTE system in a shared band without any modification, the LTE system may generally occupy the spectrum all the time, and may totally, or partially, block any other system's usage, which may be unfair and may violate a regulatory requirement of an unlicensed band. In this regard, for LTE transmissions in an unlicensed band, the LTE may need to use frequency sharing or time sharing, or both schemes, in order to coexist with other systems in a fair manner.

In some instances, a mobile terminal operating in an unlicensed band may lose synchronization in time and frequency in an instance in which there is not a continuous Common Reference Signal (CRS) in the carrier of the unlicensed band. Additionally, in an instance in which all of the carriers of an unlicensed band are occupied by coexisting systems, the tracking of the LTE system may be lost or intolerable interference may be caused to a coexisting systems operating in the unlicensed band due to high power Common Reference Signal transmissions.

As such, it may be desirable to provide an efficient and reliable mechanism that enables provision of configurable Reference Signals to minimize the interference to carriers and a coexisting system(s) of an unlicensed band.

### BRIEF SUMMARY OF EXAMPLE EMBODIMENTS

A method, apparatus and computer program product are therefore provided in accordance with an example embodiment to facilitate the provision of configurable Reference Signals for downlink communications in a frequency band (e.g., also referred to herein as band) of an unlicensed shared band. In this regard, some example embodiments may generate an ultra-low power wideband spreading RS pattern that enables a communications system (e.g., a LTE system) to keep all-time robust tracking even in an instance in which no free spectrum is available in the unlicensed band. In this regard, the interference to an active co-existence system may be negligible.

The specifically designed novel RS patterns of the example embodiments provide enhanced spectrum efficiency, reduced interference leakage and more robust tracking performance and some of the example embodiments may adaptively configure the novel RS patterns to meet different scenarios. As such, some example embodiments may facilitate optional coexistence of systems in an efficient and reliable manner.

In one example embodiment, a method is provided that includes determining whether one or more component carriers of an unlicensed band secondary component carrier are available for usage. The determined component carriers available for usage may provide at least one determined signal, among a plurality of signals, which enable timing and frequency tracking of one or more downlink carriers in response to discontinuous transmission via at least one medium of the unlicensed band. The medium of the unlicensed band was previously utilized to provide content to one or more devices. The method may further include selecting the determined signal, among the signals, based in part on a band of the component carriers and a detection indicating whether communication terminals of a coexisting system are using at least one of the component carriers associated with the band. The method may further include enabling provision of the signal to at least one of the devices via a component carrier, of the component carriers, in response to determining that the component carrier is available or via an occupied component carrier. The signal may be provided via the occupied component carrier being utilized by the coexisting system, in response to determining that each of the component carriers are unavailable to enable the device to continue tracking of timing and frequency information of the downlink carriers.

In another example embodiment, an apparatus is provided that includes at least one processor and at least one memory including computer program code with the at least one memory and the computer program code being configured to, with the at least one processor, cause the apparatus at least to determine whether one or more component carriers of an unlicensed band secondary component carrier are available for usage. The determined component carriers available for usage may provide at least one determined signal, among a plurality of signals, which enable timing and frequency tracking of one or more downlink carriers in response to discontinuous transmission via at least one medium of the unlicensed band. The medium of the unlicensed band was previously utilized to provide content to one or more devices. The at least one memory and the computer program code are also configured to, with the at least one processor, cause the apparatus to select the determined signal, among the signals, based in part on a band of the component carriers and a detection indicating whether communication terminals of a coexisting system are using at least one of the component carriers associated with the band. The at least one memory and the computer program code are also configured to, with the at least one processor, cause the apparatus to enable provision of the signal to at least one of the devices via a component carrier, of the component carriers, in response to determining that the component carrier is available or via an occupied component carrier. The signal may be provided via the occupied component carrier being utilized by the coexisting system, in response to determining that each of the component carriers are unavailable to enable the device to continue tracking of timing and frequency information of the downlink carriers.

In another example embodiment, an apparatus is provided that includes means for determining whether one or more component carriers of an unlicensed band secondary component carrier are available for usage. The determined component carriers available for usage may provide at least one determined signal, among a plurality of signals, which enable timing and frequency tracking of one or more downlink carriers in response to discontinuous transmission via at least one medium of the unlicensed band. The medium of the unlicensed band was previously utilized to provide content to one or more devices. The apparatus may further include means for selecting the determined signal, among the signals, based in part on a band of the component carriers and a detection indicating whether communication terminals of a coexisting system are using at least one of the component carriers associated with the band. The apparatus may further include means for enabling provision of the signal to at least one of the devices via a component carrier, of the component carriers, in response to determining that the component carrier is available or via an occupied component carrier. The signal may be provided via the occupied component carrier being utilized by the coexisting system in response to determining that each of the component carriers are unavailable to enable the device to continue tracking of timing and frequency information of the downlink carriers.

In another example embodiment, a method is provided that includes detecting a received signal from a network device. The network device determined whether one or more component carriers of an unlicensed band secondary component carrier are available for usage by selecting the signal, among a plurality of signals. The selection of the signal may be based in part on a band of the component carriers and a detection indicating whether communication terminals of a coexisting system are using at least one of the component carriers associated with the band. The signal enables timing and frequency tracking of one or more downlink carriers in response to discontinuous transmission via at least one medium of the unlicensed band previously utilized to receive content provided by the network device. The method may further include continuing to track timing and frequency information of the downlink carriers based in part on data of the received signal. The received signal is received via a component carrier, of the component carriers, in response to a determination by the network device that the component carrier is available or via an occupied carrier being utilized by a coexisting system in response to the network device determining that each of the component carriers of a band are unavailable.

In another example embodiment, an apparatus is provided that includes at least one processor and at least one memory including computer program code with the at least one memory and the computer program code being configured to, with the at least one processor, cause the apparatus at least to detect a received signal from a network device. The network device determined whether one or more component carriers of an unlicensed band secondary component carrier are available for usage by selecting the signal, among a plurality of signals. The selection of the signal may be based in part on a band of the component carriers and a detection indicating whether communication terminals of a coexisting system are using at least one of the component carriers associated with the band. The signal enables timing and frequency tracking of one or more downlink carriers in response to discontinuous transmission via at least one medium of the unlicensed band previously utilized to receive content provided by the network device. The at least one memory and the computer program code are also configured to, with the at least one processor, cause the apparatus to continue to track timing and frequency information of the downlink carriers based in part on data of the received signal. The received signal is received via a component carrier, of the component carriers, in response to a determination by the network device that the component carrier is available or via an occupied carrier being utilized by a coexisting system in response to the network device determining that each of the component carriers of a band are unavailable.

In another example embodiment, an apparatus is provided that includes means for detecting a received signal from a network device. The network device determined whether one or more component carriers of an unlicensed band secondary component carrier are available for usage by selecting the signal, among a plurality of signals. The selection of the signal may be based in part on a band of the component carriers and a detection indicating whether communication terminals of a coexisting system are using at least one of the component carriers associated with the band. The signal enables timing and frequency tracking of one or more downlink carriers in response to discontinuous transmission via at least one medium of the unlicensed band previously utilized to receive content provided by the network device. The apparatus may further include means for continuing to track timing and frequency information of the downlink carriers based in part on data of the received signal. The received signal is received via a component carrier, of the component carriers, in response to a determination by the network device that the component carrier is available or via an occupied carrier being utilized by a coexisting system in response to the network device determining that each of the component carriers of a band are unavailable.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is one example of a communications system according to an example embodiment of the invention;

FIG. 2 is a diagram of a system according to an example embodiment of the invention;

FIG. 3 is a schematic block diagram of an apparatus from the perspective of a base station in accordance with an example embodiment of the invention;

FIG. 4 is a block diagram of an apparatus from the perspective of a terminal in accordance with an example embodiment of the invention;

FIG. 5 is a diagram illustrating a configurable Reference Signal pattern according to an example embodiment of the invention;

FIG. 6 is a diagram illustrating a configurable ultra-low power wideband Reference Signal pattern according to an example embodiment of the invention;

FIG. 7 illustrates a diagram of a table of parameters utilized to evaluate Carrier Frequency Offset and timing tracking performance of a communications system;

FIG. 8 is a diagram illustrating a Carrier Frequency Offset estimation Mean Square Error of tracking performance in a communications system according to an example embodiment of the invention;

FIG. 9 is a flowchart illustrating operations performed in accordance with one example embodiment of the invention; and

FIG. 10 is a flowchart illustrating operations performed in accordance with another example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this teuu in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, in some example embodiments, a tracking carrier(s) may, but need not, refer to a carrier(s) such as, for example, a medium(s) or channel(s) configured to provide timing and frequency information to one or more communication devices (e.g., User Equipment (UE(s)).

As referred to herein, a Physical Resource Block(s) (PRB(s) may denote a selection and allocation of physical transport carriers (e.g., sub-carriers) and the time intervals the physical transport carriers may use to transport data.

As referred to herein, a wideband may, but need not, denote a wide range of frequencies in a spectrum such as, for example, an unlicensed band. Additionally, as referred to herein, a narrowband may denote a carrier, channel, medium or the like that occupies a small amount of frequency space in a spectrum such as, for example, an unlicensed band. As referred to herein, an ultra-wideband may, but need not, denote a bandwidth communications using a large portion of a frequency spectrum, such as, for example, an unlicensed band at very low power/energy levels.

As referred to herein, a Zadoff Chu (ZC) sequence may, but need not, denote a mathematical based sequence applied to radio signals (e.g., Reference Signals) and create an electromagnetic signal of a constant amplitude in which cyclically shifted versions of the sequence may, but need not, be imposed on a signal resulting in zero cross-correlation.

As described above, in order to provide LTE transmissions in unlicensed band, an LTE system may need to utilize frequency sharing or time sharing, or both schemes, in order to coexist with other systems (e.g., a WiFi system, a WLAN system) in an unlicensed band in a fair manner. For instance, when an LTE system is deployed in a shared band such as, for example, a licensed band and an unlicensed band, without any modification, the LTE system may continuously transmit and may keep on occupying the spectrum all the time and may block another system's usage. Thus, a discontinuous type of transmission may be needed for an LTE system.

In this regard, during a turned off period, the LTE system may typically shut off all transmissions to allow transmissions via a medium for another system. The turn off of LTE system typically relates to turning off all channels of an LTE uplink as well as a LTE downlink, since any signal may cause another system(s) (e.g., a WiFi system, a WLAN system) to misinterpret that the medium is busy.

In this scenario, in an instance in which the LTE system may turn off all transmissions to allow another system to utilize a medium(s) of an unlicensed band, a UE may lose synchronization in time and frequency since there may be no continuous Common Reference Signal (CRS) transmission in this carrier (e.g., a medium (e.g., a channel(s)) of an unlicensed band). After an evolved Node B (eNB) turns on the communications system again, the UE may need some time to perform time and frequency compensation first before the UE is able to start reliably receiving and/or transmitting data. For instance, in general, before a UE may start reliably receiving data such as, for example, a packet(s), the UE may need to perform timing and frequency offset compensation before channel estimation. The time and frequency offset may take some time for an UE to reach enough accuracy in an instance in which the turn off period may be long.

On the other hand, in an instance in which an LTE system is turned on in an unlicensed band, it is typically desirable that the UE may be able to start receiving data such as, for example, a packet(s) immediately to improve the efficiency of resource utilization due to a potential limited turn on period. For example, in order for a medium busy traffic 802.11 system to maintain a reasonable delay, less than 50 ms extra delay may be desired. In this regard, an LTE system may use a channel that becomes available for a duration prior to expiration of, or up to, 50 ms.

As such, some example embodiments may provide a reliable manner in which to enable communication devices such as, for example, UEs to obtain time and frequency information in a fast and efficient manner based in part on providing a configurable Reference Signal in a carrier of the unlicensed band.

The configurable Reference Signals of the example embodiments may be determined based on analyzing at least three scenarios in which an LTE system may operate in an unlicensed band.

The first scenario may relate to a free wideband carrier that is available for LTE downlink transmissions, where no other coexisting systems may be present. Therefore, the channel condition(s) of the carrier may be suitable and as such data such as, for example, the CRS symbols are multiplexed with the data symbols that may be transmitted.

The second scenario may relate to a free narrowband (e.g., a guard band) carrier that may be available for LTE downlink transmissions, where adjacent bands may be occupied by other coexisting (e.g., a WiFi system) systems. In this scenario, the interference from adjacent bands may be high and thus transmission of data symbols may result in significantly degraded performance. In addition, transmitting data symbols in this narrowband may cause massive interference to operating systems in adjacent bands. Therefore, the narrowband may typically be unsuitable for reliable data transmission.

The third scenario may relate to a free band being unavailable for LTE downlink transmissions in a very wide frequency range. In this regard, all of the frequency (e.g., carriers (e.g., channels)) of an unlicensed band may be occupied by other coexisting systems and a LTE system may perform time shared transmissions with the coexisting systems.

Based on these three scenarios, the example embodiments may determine multiple Reference Signal (RS) patterns (e.g., three RS patterns in one example embodiment) for an LTE system to address the challenges arising from these three scenarios.

In the first scenario, the CRS is typically sufficient for tracking timing and frequency information and thus no extra modification of a legacy LTE system may be needed in an instance in which a free wideband carrier is available. Regarding the second scenario, there typically may not be any data transmission suggested due to the interference concerns of the adjacent bands. As such, a new RS design, of the example embodiments, may be beneficial to minimize the interference leakage to the adjacent bands. As described above, in the third scenario, no free band carrier may be available at all. As such, the LTE system may need to turn off its normal transmission to avoid collisions with other systems (e.g., an ISM system (e.g., a WiFi system, a WLAN system)). The example embodiments may generate/design a reference signal to address issues with respect to the third scenario based in part on considering a manner in which to achieve (1) negligible interference to ongoing ISM system, and (2) being robust enough against the interference to meet a tracking performance requirement. For example, in an example embodiment, the tracking performance requirement may limit the Carrier Frequency Offset (CFO) within ±25 ppm, which is about 1% of a subcarrier spacing.

At present, existing RS patterns available in legacy LTE systems are typically insufficient to address the issues associated with the second (e.g., interference to adjacent bands) and third scenarios (e.g., no free band being available). The example embodiments may generate one or more configurable RS patterns to solve the above-described problems associated with each of the carriers of an unlicensed band being occupied by coexisting systems such that the tracking of the LTE system may be lost or due to intolerable interference with coexisting systems due to high power Reference Signal transmissions.

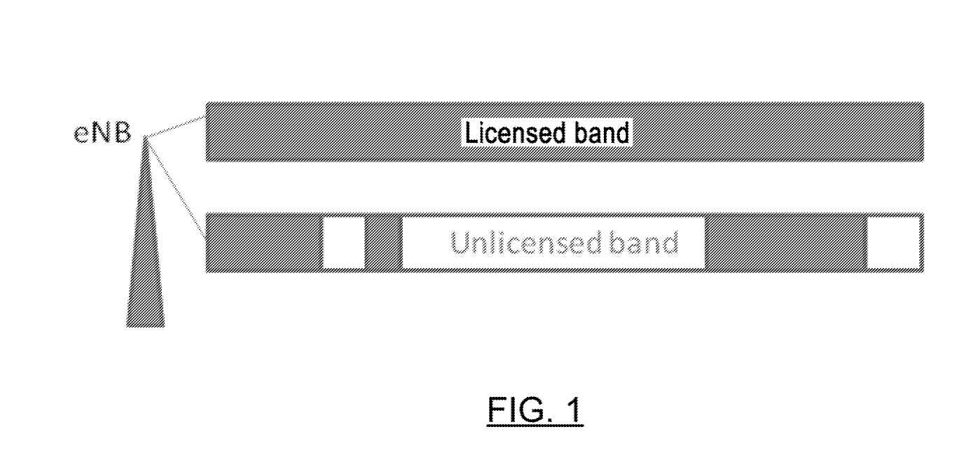

Referring now to FIG. 1, in accordance with an example embodiment of the invention, a communication system is provided in which a network entity, such as, for example, an access point, a base station, an evolved node B (eNB) or the like, may utilize carrier aggregation and in this regard may communicate with a licensed band carrier(s) as well as an unlicensed band carrier(s).

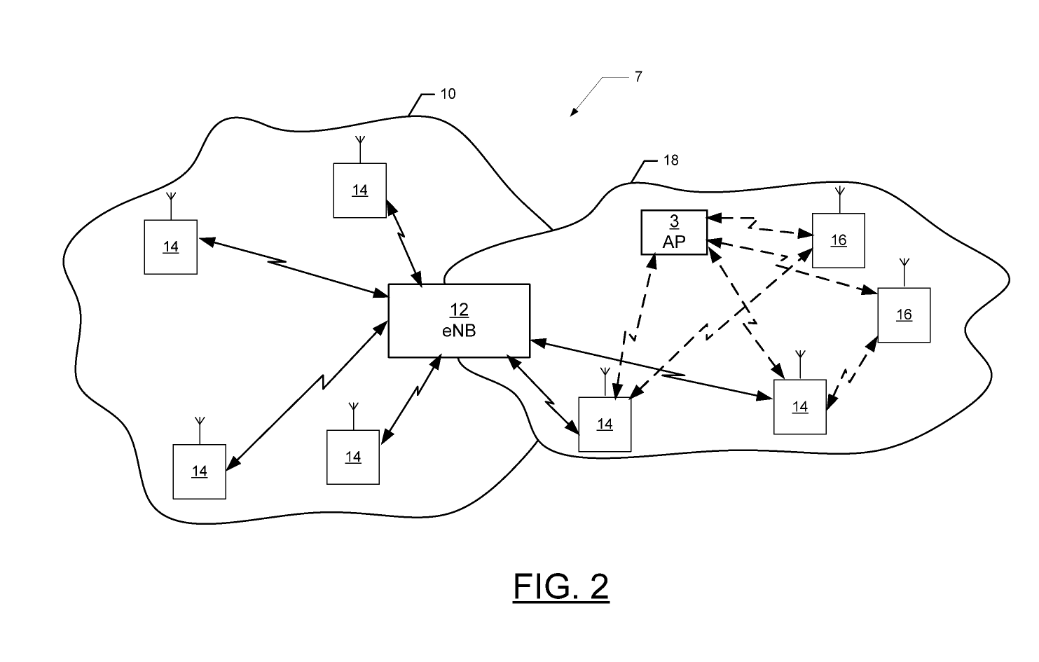

Referring now to FIG. 2, a schematic block diagram of a communications system according to an example embodiment is provided. In the example embodiment of FIG. 2, the base station, an evolved node B (eNB) 12 (also referred to herein as a base station 12) or the like, may communicate with a plurality of terminals in the licensed spectrum and may optionally communicate in a license exempt band 18 (also referred to herein as unlicensed band 18), such as within the ISM band or the TVWS band. While a communications system that provides coordination of communication using carrier aggregation in a licensed band and an unlicensed band may be configured in various different manners, FIG. 2 illustrates a generic system diagram in which a terminal, such as a mobile terminal, may communicate in a licensed spectrum, as well as in license exempt band 18, with the network 10, such as by the exchange of cellular signals as shown in the solid lightening bolts in FIG. 2. In addition, the mobile terminal may communicate in a license exempt band 18, such as, but not limited to, the ISM band and/or TVWS, and in the license exempt band there may be other terminals/networks communicating with each other as shown in the dashed lightening bolts. As shown in FIG. 2, an embodiment of a system 7 in accordance with an example embodiment of the invention may include a set of first terminals 14 and a set of second terminals 16. The first terminals 14 may each be capable of communication, such as cellular communication, in the licensed band, as well as in the license exempt band, with a network 10 (e.g., a cellular network). Some terminals 16 may form another network, which may be a cellular system(s) or non-cellular system(s). The first terminals 14 may be configured to communicate (e.g., directly) with one or more of the second terminals 16 as well as at least one access point (AP) 3 (e.g., a Wifi AP, a wireless local area network (WLAN) AP) in a license exempt band 18. The first terminals 14 may be configured to listen to signaling on the license exempt band 18. While each set of the first and second terminals is shown to include multiple terminals, either set or both sets may include a single terminal in other embodiments. While the cellular network may be configured in accordance with Long Term Evolution (LTE), the network may employ other mobile access mechanisms such as wideband code division multiple access (W-CDMA), CDMA2000, global system for mobile communications (GSM), general packet radio service (CPRS), LTE-Advanced (LTE-A) and/or the like. The non-cellular network may be configured in IEEE 802.11 systems or other shared band technologies (e.g., TVWS).

The network 10 may include a collection of various different nodes, devices or functions that may be in communication with each other via corresponding wired and/or wireless interfaces. As such, the illustration of FIG. 2 should be understood to be an example of a broad view of certain elements of the system and not an all inclusive or detailed view of the system or the network. One or more communication terminals such as the first terminals 14 and second terminals 16 may be in communication with each other or other devices via the licensed band of the network 10 and/or the unlicensed band 18. In some cases, each of the communication terminals may include an antenna or antennas for transmitting signals to and for receiving signals from an access point (e.g., AP 3), base station, node B, eNB (e.g., eNB 12) or the like. Although one eNB 12 and on AP 3 is shown as part of the system of FIG. 2, it should be pointed out that any suitable number of eNBs 12 and APs 3 may be part of the system of FIG. 2 without departing from the spirit and scope of the invention. The eNB may be, for example, part of one or more cellular or mobile networks or public land mobile networks (PLMNs). In turn, other devices such as processing devices (e.g., personal computers, server computers or the like) may be coupled to the terminals via the network.

In some example embodiments, the first terminals 14 may be one or more mobile communication devices (e.g., user equipment (UE)) such as, for example, a mobile telephone, portable digital assistant (PDA), pager, laptop computer, or any of numerous other hand held or portable communication devices, computation devices, content generation devices, content consumption devices, or combinations thereof. Alternatively, the first terminals may be fixed communication devices that are not configured to be mobile or portable. In either instance, the terminals may include one or more processors that may define processing circuitry either alone or in combination with one or more memories. The processing circuitry may utilize instructions stored in the memory to cause the terminals to operate in a particular way or execute specific functionality when the instructions are executed by the one or more processors. The first terminals may also include communication circuitry and corresponding hardware/software to enable communication with other devices.

The second terminals 16 may be communication devices such as, for example, a WiFi station, a WLAN station (according to a WLAN technique such as, for example, IEEE 802.11 techniques), a Bluetooth station or the like(s)). The second terminals may be configured to communicate with the AP 3 (e.g., a WiFi AP, a WLAN AP) as well as the first terminals 14.

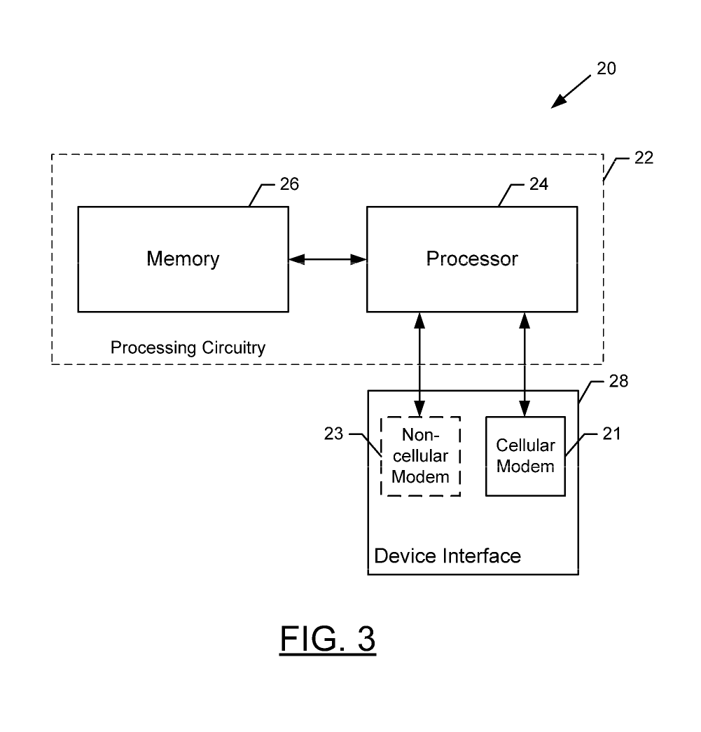

Referring now to FIG. 3 a schematic block diagram of an apparatus according to an example embodiment is provided. In the example embodiment of FIG. 3, the eNB 12 may be embodied as or otherwise include an apparatus 20 as generically represented by the block diagram of FIG. 3. In this regard, the apparatus may be configured to communicate with the sets of first and second terminals 14, 16. While one embodiment of the apparatus is illustrated and described below, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the invention. In some example embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28. As such, the processing circuitry may be embodied as a circuit chip (e.g., an integrated circuit chip) configured (e.g., with hardware, software or a combination of hardware and software) to perform operations described herein in relation to the eNB 12.

The device interface 28 may include one or more interface mechanisms for enabling communication with other devices, such as the sets of first and second terminals 14, 16. In some cases, the device interface may be any means such as a device or circuitry embodied in either hardware, or a combination of hardware and software that is configured to receive and/or transmit data from/to a network and/or any other device or module in communication with the processing circuitry 22. In this regard, the device interface may include, for example, an antenna (or multiple antennas) and supporting hardware and/or software for enabling communications with a wireless communication network and/or a communication modem, such as a cellular modem 21 (e.g., an LTE modem), and/or an optional non-cellular modem 23 (e.g., a Wifi modem, WLAN modem, etc.) for enabling communications with the sets of first and second terminals. In an example embodiment the cellular modem 21 may be configured to facilitate communications via a primary cell (PCell) on a licensed band (for example, of network 10) and the non-cellular modem 23 may be able to facilitate communications via a secondary cell (SCell) on the unlicensed band 18.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry in—the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

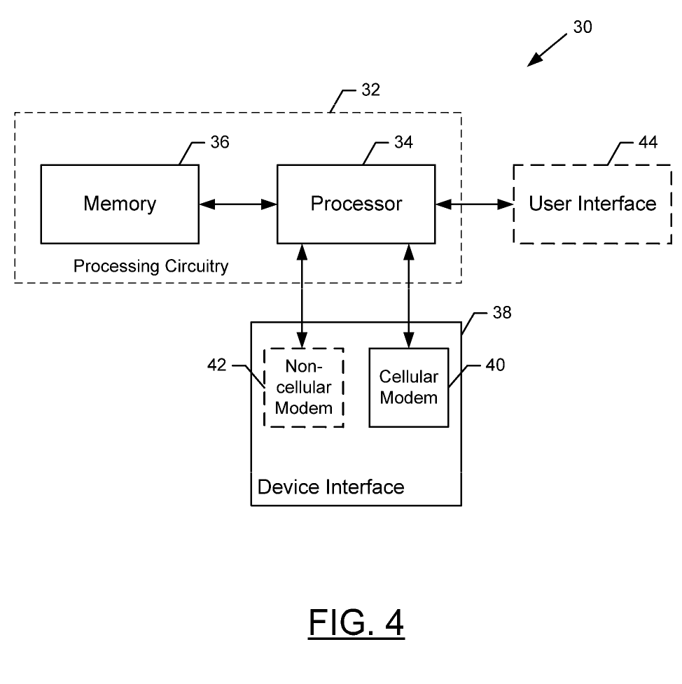

In one embodiment, the first terminals 14 (also referred to herein as user equipment (UE) 14) may be embodied as or otherwise include an apparatus 30 as generically represented by the block diagram of FIG. 4. In this regard, the apparatus may be configured to provide for communications in the licensed spectrum, such as cellular communications, with the eNB 12 or another terminal and communications in the license exempt band, such as non-cellular communications, with another terminal (e.g., second terminal 16, AP 3). While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 4, the apparatus 30 may include or otherwise be in communication with processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 44. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal, the processing circuitry may be embodied as a portion of a mobile computing device or other mobile terminal.

The optional user interface 44 may be in communication with the processing circuitry 32 to receive an indication of a user input at the user interface and/or to provide an audible, visual, mechanical or other output to the user. As such, the user interface in the context of a mobile terminal may include, for example, a keyboard, a mouse, a joystick, a display, a touch screen, a microphone, a speaker, and/or other input/output mechanisms.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In the illustrated embodiment, for example, the device interface includes a cellular modem 40 (e.g., an LTE modem) for supporting communications in the licensed spectrum, such as communications with the eNB 12, and an optional non-cellular modem 42 (e.g., a WiFi modem, WLAN modem, Bluetooth (BT) modem, etc.) for supporting communications in the license exempt band 18, such as non-cellular communications, e.g., communications in the ISM band and/or the TVWS band, with other terminals (e.g., second terminals 16 (e.g., a WiFi station(s), a WLAN station(s)), etc.), as well as AP 3, or any other suitable devices.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC, an FPGA or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In some example embodiments, an eNB (e.g., eNB 12 (e.g., LTE eNB 12)) may need to turn off transmissions (e.g., LTE transmissions) in an unlicensed band (e.g., unlicensed band 18) from time to time to allow transmissions of other systems (e.g., a WiFi system, a WLAN system, etc.). For instance, the turning off of the transmissions, by the eNB (e.g., eNB 12), may relate to turning off one or more channels (e.g., a medium (for example, a wireless medium)) in the unlicensed band 18 that were previously being utilized by the eNB to communicate with one or more UEs. Before a UE 14 may start receiving data including, but not limited to, a packet(s), the UE 14 may need to perform timing and frequency offset compensation before channel estimation. During the turned off period, some example embodiments may enable one or more UEs 14 to utilize a medium (e.g., channel(s)) in an unlicensed band (e.g., unlicensed band 18) to enable the UEs 14 to perform frequency and time tracking based in part on the UE 14 utilizing a Reference Signal(s) (e.g., a Zadoff-Chu Reference Signal) received, via the medium, from the eNB 12. In this regard, the UEs 14 of the example embodiments may not lose synchronization in time and frequency after the eNB 12 turns on the transmissions (e.g., LTE transmissions) to the channel(s) that were previously being used by the eNB 12 to communicate with the UEs 14. In this manner, the UEs 14 may start receiving data immediately.

In order to further optimize the tracking performance of an LTE system, the eNB 12 may utilize a Zadoff-Chu (ZC) sequence based RS pattern in a free narrowband channel(s) (e.g., a guard band) in an unlicensed band (e.g., unlicensed band 18) and in instances in which there are no free channels available in an unlicensed band. In this regard, for example, the eNB 12 may define and generate a novel ultra-low power wideband RS pattern for usage instead of an existing CRS signal of a Legacy LTE system (in which these existing CRS signals are typically not configurable) in instances in which channels of an unlicensed band (e.g., unlicensed band 18) may be unavailable. Although an LTE system and WiFi system may be referred to below with respect to implementation of the ZC sequence based RS patterns, as an example, the ZC sequence based RS patterns of the example embodiments may be utilized for any spectrum time sharing scenario(s)/system(s).

As described above, in an example embodiment, the eNB 12 may define and generate a novel configurable ZC sequence based RS pattern. In this regard, the eNB 12 may apply a ZC sequence based RS to perform tracking (e.g., to maintain timing and frequency alignment) via a free narrowband carrier (e.g., a channel (e.g., a guard band)) of an unlicensed band 18 and in an instance in which there may be no free band (e.g., channels) available in the unlicensed band 18. For instance, even though there may not be any channels available for example, the channels are being used by a coexisting system (e.g., a WiFi system)) in the unlicensed band, the eNB 12 may be able to send a low power ZC sequence based RS to the UE 14, via one of these occupied channels. The low power ZC sequence based RS may enable the UE 14 to perform timing and synchronization. The ZC sequence based RS may not cause interference on the channels being occupied by the coexisting system since the power may be very low. Instead, the coexisting system may detect the ZC sequence based RS as background noise.

The ZC sequence may utilize all the Resource Elements (REs) available instead of leaving null REs as in an existing Common Reference Signal to achieve higher spreading gain. As referred to herein, a RE may correspond to a subcarrier in an OFDM system and the subcarrier may be the minimum unit carrying the modulated information symbols associated with a communications system (e.g., a LTE system). In a communications system such as, for example, a LTE system, CRS symbols are sparsely allocated across the spectrum, and REs between two CRS symbols are used for data transmission. In this scenario, the data transmission may be impractical due to low power and thus these REs may be utilized in an example embodiment for tracking a sequence(s) instead of leaving them empty. Instead of the fixed bandwidth and pattern CRS adopted in a legacy LTE system, the pattern of the ZC sequence of the example embodiments is highly configurable, by the eNB, to meet the varying requirements of LTE Carrier Aggregation in an unlicensed band.

The bandwidth of the ZC sequence may be configurable by the eNB 12 to tradeoff between interference coordination and tracking performance. For instance, a minimum bandwidth of 7 Physical Resource Blocks (PRBs) similar to Primary Synchronization Sequence (PSS) and Secondary Synchronization Sequence (SSS) may be supported as well as a bandwidth, such as, for example, a bandwidth up to a maximum 20 MHz or a maximum of 100 MHz. The PSS and/or the SSS may be used for initial synchronization in an example embodiment.

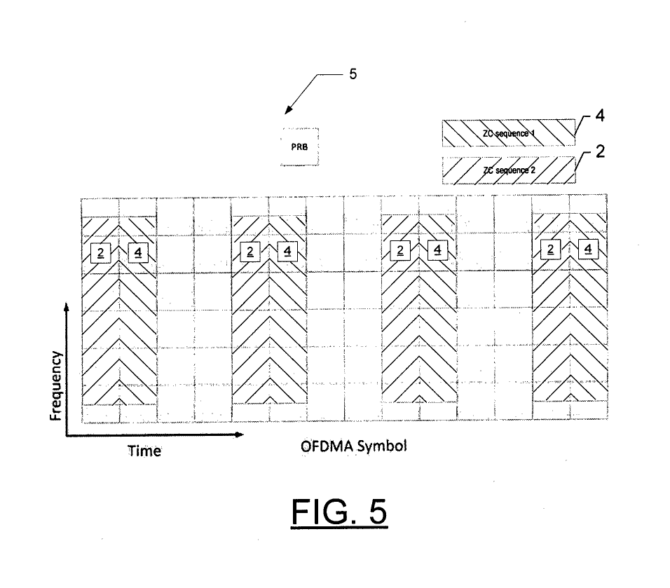

The sequence power and associated pattern may be configurable, by the eNB 12, to minimize the interference to/from an LTE system. The first issue concerning the generation of the ZC sequence based RS pattern of the example embodiments may involve the number of sequences available within a time interval. When the sequence power is very low (e.g., background noise power (e.g., −474 dBm/Hz)), for example as configured in an instance in which there are no free channels available to minimize interference with coexisting systems and avoid collision, this sequence power should both guarantee enough spreading gain and limit the process delay. In addition, rather than locating all sequences in consecutive Orthogonal Frequency-Division Multiple Access (OFDMA) symbols, the processor of the eNB 12 may include an intentioned gap between any two sequences. (See e.g., FIG. 5) Based in part on the eNB 12 determining the channel availability and the statistics of coexisting systems, as well as jointly configuring the sequence power and the intentioned gap, the eNB 12 may significantly reduce the interference to coexisting systems.

The eNB 12 may configure and alternate the selected RS pattern based on the detected channel conditions of the unlicensed band (e.g., unlicensed band 18). The parameters of the RS patterns transmitted by the eNB 12, such as, for example, bandwidth, pattern and duration may be implicitly or explicitly informed/provided to the UEs 14.

An exemplary manner in which the eNB 12 may generate RS based patterns may be based on the following approaches: (1) in an instance in which the tracking carrier is in a free wideband (e.g., a free channel of an unlicensed band (e.g., unlicensed band 18) that is available and not being utilized by a coexisting system), the eNB 12 may transmit a Common Reference Signal according to the same pattern as in a normal LTE downlink transmission; (2) in an instance in which the tracking carrier is placed in a free narrowband channel (e.g., a guard band, where adjacent bands may be occupied by coexisting systems (e.g., WiFi systems)), the eNB 12 may inform the UEs that a ZC sequence based RS may be provided, associated with the selected bandwidth and periodicity, for performing tracking and timing information; and (3) in an instance in which the eNB 12 turns off its transmission and does not identify a free band available in the unlicensed band (e.g., unlicensed band 18), the eNB 12 may switch to an ultra-low power wideband RS mode and may provide an ultra-low power wideband RS to the UE 14 to perform timing and frequency synchronization.

In an instance in which the eNB 12 does not identify any free channels in the unlicensed band (e.g., unlicensed band 18), the eNB 12 may first determine the bandwidth (e.g., number of Carrier Aggregations) and the pattern including the gap duration and periodicity which may then be signaled to a UE(s) 14 by the eNB 12. Then, processor 24 of the eNB may set the RS transmission power of the ZC sequence to an ultra-low level which may satisfy a tracking performance requirement, as described more fully below. The processor 24 of eNB 12 may also be able to determine whether or not to transmit the ultra-low power RS signals due to detected interference concerns.

The eNB 12 may provide the ZC sequence based RS by downlink signaling via newly-designed Layer 1 (L1)/Media Access Control (MAC)/Radio Resource Control (RRC) signaling or by integrating the RS parameter(s) with the other signaling, e.g., an ON/OFF configuration signaling of the eNB 12.

A processor 34 of a UE (e.g., UE 14) may first detect the ZC sequence based RS pattern(s) via downlink signaling from the eNB 12. In response to receipt of the ZC sequence based RS pattern(s), the processor 34 of the UE may implement a corresponding tracking procedure to perform timing and frequency synchronization based on the received RS parameters of the ZC sequence based RS pattern(s). In an example embodiment, RS parameters may include, but are not limited to, bandwidth, a sequence identifier (ID), sequence positions and periodicity, transmission power and any other suitable parameters. The tracking procedure implemented by the processor 34 of the UE may extract the frequency and timing estimates from the received sequence signal. The tracking procedure may, but need not, relate to different tracking algorithms.

The processor 34 of the UE may be able to perform tracking based on different RS patterns. The processor 34 of the UE may implement a stored tracking algorithm(s) to obtain the frequency and timing estimates. However, the tracking algorithm may need to have prior knowledge of the sequence used for tracking in order for the processor 34 of the UE to execute the tracking algorithm. After detecting a RS pattern of the ZC sequence based RS by examining a downlink control signal, the processor 34 of the UE may select a best tracking mechanism to start tracking from a predefined timing instant. In one example embodiment, the UE may select a best tracking mechanism from several pre-stored tracking algorithms to perform a current tracking task. In one example embodiment, the predetermined timing instant may, but need not, correspond to a time after successfully detecting a command of the eNB 12 to receive tracking signals.

Once a UE 14 is informed, by the eNB 12, that the RS pattern is changed, the processor 34 of the UE 14 may be able to switch to a corresponding tracking mechanism. For example, in an instance in which the eNB 12 switches from an “on” to “off” status, the UE 14 may stop checking for the detection of ZC sequence based RS and may start accumulating all the symbols in the wideband. For instance, the eNB 12 may change the transmitted RS pattern from time to time and may inform UE 14 of this change. In this regard, the UE 14 may need to change the tracking algorithm m being used/executed by the processor 34 of the UE 14. The position of a CRS currently being utilized by the UE 14 is different from the ultra-low power wideband ZC sequence based RS. As such, in an instance in which the UE 14 detects that the RS pattern changes, the UE 14 may stop utilizing the CRS and may switch to using the ultra-low power wideband ZC sequence based RS.

For purposes of illustration and not of limitation, the eNB 12 may change may change a RS pattern based on changes in channel conditions. For instance, when the eNB detects a free wideband for downlink transmission in which no other coexisting system may be present, the eNB 12 may transmit a Common Reference Signal to the UE 14 via a free wideband channel of an unlicensed band. The Common Reference Signal may have a sequence that is sparsed in which the reference signal may be spread over a band so that there are some places between each reference signal reserved for data transmission. However, in an instance in which there are no longer any free channels available in the unlicensed band such as, for example, when each of the channels are being utilized by a coexisting system (e.g., WiFi system), the eNB 12 may change the RS pattern to an ultra-low power wideband ZC sequence based RS.

Referring now to FIG. 5, a diagram illustrating an example embodiment of a ZC sequence based RS according to an example embodiment is provided. The ZC sequence based RS pattern 5 (also referred to herein as ZC sequence 5) of the example embodiment of FIG. 5 may be provided by the eNB 12 to the UE 14 in a free narrowband (e.g., a narrow channel) of an unlicensed band (e.g., unlicensed band 18). In the free narrowband (e.g., a carrier (e.g., a guard band) of the unlicensed band, adjacent bands may be occupied by other coexisting systems, as described above. In the example embodiment of FIG. 5, the whole band (e.g., the free narrowband) may be available for tracking Reference Signals, and the Reference Signal(s) symbols may be allocated to the center of the band (e.g., a guard band) to minimize the interference leakage to adjacent bands. In order to maximize the reuse of an LTE system (e.g., even a legacy LTE system), the eNB 12 may apply the ZC sequence 5 in a similar manner to a PSS signal. That is, every sequence may be a 63-length ZC sequence 5 which is generated by the processor 24 of the eNB 12 and placed in the central 6 PRBs of an OFDMA. The ZC sequence based RS pattern 5 of the example embodiment of FIG. 5 may be centralized across the band (e.g., a channel) and as shown in FIG. 5, the ZC sequence based RS pattern 5 may correspond to one OFDMA symbol. For purposes of illustration and not of limitation, the eNB 12 may concentrate the ZS sequence based RS pattern 5 in a gap channel (e.g., a gap band), in an instance in which a coexisting system (e.g., a Wi-Fi system) may not be using this gap channel. As such, the eNB 12 may use this gap channel, for example for downlink transmissions to the UE 14 to enable the processor 34 of the UE 14 to perform timing and synchronization. For instance, this gap channel (e.g., a narrow channel) may, but need not be, a gap band between adjacent Wi-Fi bands. Although the Wi-Fi system may be using channels of the unlicensed band, the WiFi system may not be using the gap channels and such the eNB 12 may use these gap channels for downlink communications.

The ZC sequence based RS pattern 5 of the example embodiment of FIG. 5 may be centralized by the eNB 12 across the band (e.g., the channel) and as shown in FIG. 5, the ZC sequence based RS 5 may, but need not, correspond to one OFDMA symbol.

Two ZC sequences 2, 4 may be generated, via the processor 24 of the eNB 12, by multiplexing a different cover and then transmitted, via the eNB 12 to the UE 14, continuously/periodically in every four OFDMA symbols as illustrated in FIG. 5. In this regard, two ZC sequences 2, 4 are available in each radio frame of a ZS based sequence RS pattern 5 separated by two gaps (e.g., corresponding to two carrier component (CC) frequencies) of OFDMA symbols. As such, for every four symbols, for the first two symbols of the four symbols, the eNB 12 may transmit the ZC sequences 2, 4 which may be configurable. Additionally, each block of the ZC sequence based RS pattern 5 may correspond to a Physical Resource Block (PRB). The ZC sequence based RS pattern 5 of FIG. 5 may be associated with two axes, for instance, a time axis and a frequency axis. The time axis corresponds to blocks in which one block denotes one symbol. The frequency axis, corresponds to blocks in which one block denotes one PRB which corresponds to one subcarrier. In one example embodiment, the ZC sequence 2 and the ZC sequence 4 may have a different power.

Upon receipt of the OFDMA symbols, the Carrier Frequency Offset may be estimated by the processor 34 of the UE 14 by examining the phase shift between two sequences. In addition, the processor 34 of the UE 14 may perform timing tracking by cross-correlation or auto-correlation as well as by a hybrid mechanism. It should be pointed out that the example embodiment of the ZC sequence based RS pattern 5 of FIG. 5 is one example of an RS pattern. In some alternative example embodiments, the ZC sequence based RS pattern 5 may be configurable by the eNB 12 based in part on bandwidth and periodicity or any other suitable parameters or resources.

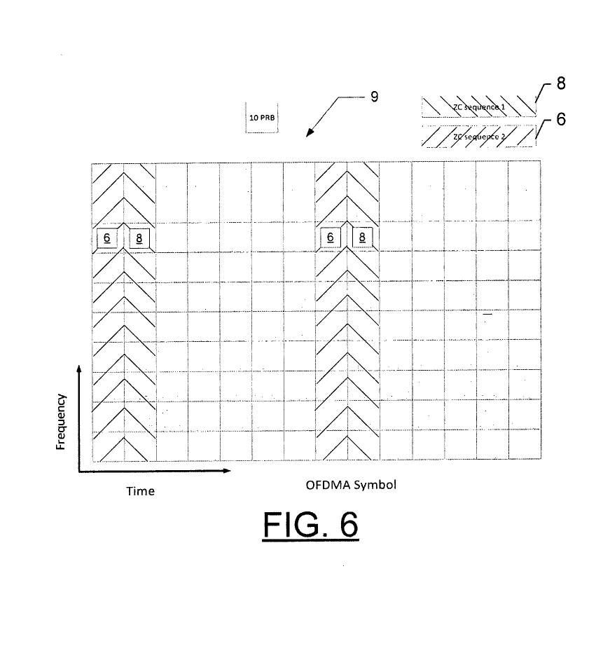

Referring now to FIG. 6, an example embodiment of an ultra-low power wideband RS pattern according to an example embodiment is provided. In the example embodiment of FIG. 6, the ultra-low power wideband RS pattern 9 (also referred to herein as ZC sequence based RS pattern 9) may be utilized by an eNB 12 in an unlicensed band in an instance in which the processor 24 of the eNB 12 determines that there are not any free bands available in the unlicensed band (e.g., unlicensed band 18). In this regard, the processor 24 of the eNB 12 may determine that a coexisting system of the unlicensed band is utilizing all of the channels of the unlicensed band. Although each of the channels may be used by a coexisting system, in this example embodiment, the eNB 12 may transmit a ZC based RS pattern 9 in one or more of the channels being utilized by the coexisting system (e.g., a WiFi system, WLAN system). For instance, the eNB 12 may transmit a ZC sequence based RS pattern 9 in one or more of the channels being utilized by the coexisting system since the power of the ZC sequence based RS pattern 9 is low such that the coexisting system detects the ZC sequence based RS pattern 9 as background noise. The background noise may not cause interference to the channels being utilized by the coexisting system, as described more fully below.

In the example embodiment of FIG. 6, in each radio frame corresponding to an ultra-low power wideband ZC sequence based RS pattern 9, the processor 34 of the eNB 12 may place one pair of the ZC sequences 6, 8 at the OFDMA symbols located in front part of each slot (e.g., a LTE slot including 7 OFDMA symbols), as illustrated in FIG. 6. As a result, a ZC sequence 6 and a ZC sequence 8 may be available in each radio frame separated by gaps of 5 OFDMA symbols. The ZC sequence 6 and the ZC sequence 8 may, but need not, have a different power. Each block of the OFDMA symbols of the ultra-low power wideband ZS sequence based RS pattern 9 may correspond to 10 Physical Resource Blocks. The wider gap between ZC sequences 6, 8 may be based on transmissions of a coexisting system (e.g., WiFi transmissions) utilizing each of the channels of an unlicensed band (e.g., unlicensed band 18). Transmissions of a coexisting system such as, for example, Wifi transmissions are typically three-four OFDMA symbols in length. As such, the transmissions of the WiFi may not collide with the transmissions of ZC sequences 6, 8 being transmitted by the eNB 12 to UE 14 in a corresponding channel since the length/duration per transmission is, for example, 5 gaps of OFDMA symbols.

In this manner, based in part on the processor 24 of the eNB 12 generating a low power RS transmission associated with the ultra-low power wideband ZC sequence based RS pattern and defining gaps (e.g., 5 gaps) that are longer than a normal WiFi transmission may ensure that the interference caused by the eNB 12 (e.g., an eNB 12 of an LTE system) to a coexisting system such as, for example, a WiFi system is generally tolerable, and thus the resultant performance degradation may be insignificant.

The ultra-low power wideband RS pattern 9 may have a low power (e.g., energy level (e.g., a background noise power (e.g., −174 dBm/Hz)) for wide-bandwidth communications by using a large portion of a carrier in an unlicensed band (e.g., unlicensed band 18) for communications. In this example embodiment, the carrier (e.g., channel) may be occupied by a coexisting system (e.g., a WiFi system). The eNB 12 may spread the ultra-low power wideband RS pattern 9 over a wideband by spreading the ZC sequence 6 over 10 PRBs and spreading the ZC sequence 8 over 10 PRBs, in the example embodiment of FIG. 6. However, it should be pointed out that the ultra-low power wideband RS pattern 9 may be configurable by the eNB 12 and may be spread across a different number of PRBs. Additionally, the gaps of OFDMA symbols between the ZC sequences 6, 8 may be configurable and may be other than 5 gaps. The ultra-low power wideband RS pattern 9 may be transmitted by the eNB to the UE in a carrier occupied by the coexisting system and may not cause interference to the coexisting system, as described more fully below.

The ultra-low power wideband RS pattern 9 may be transmitted by the eNB 12 to UE 14 via a carrier of the unlicensed band (e.g., unlicensed band 18) currently being used by a coexisting system (e.g., a WiFi system, a WLAN system, etc.), however the ultra-low power wideband RS pattern 9 may not cause interference with coexisting system, as described more fully below. Timing and synchronization performance by the UE 14 detecting and using the ultra-low power wideband RS pattern 9 may be based in part on bandwidth and power. As such, since the carrier is being occupied by a coexisting system, a high power transmission may cause interference with the coexisting system using the carrier. The ultra-low power wideband RS pattern 9 generated by the processor 24 of the eNB 12 addresses this issue by using a low power transmission that may not cause interference to the carrier used by the coexisting system since the ultra-low power wideband RS pattern 9 may be detected by the coexisting system as background noise, as described more fully below. However, since the power is low, the ultra-low power wideband RS pattern 9 may need to be spread by the eNB 12 across a wider band to achieve a sufficient transmission power. On the other hand, for example, in an instance in which an RS is transmitted with a high power, a smaller frequency band may be utilized. However, a comparable performance may be achieved based in part on the eNB 12 using a wider band at a lower power.

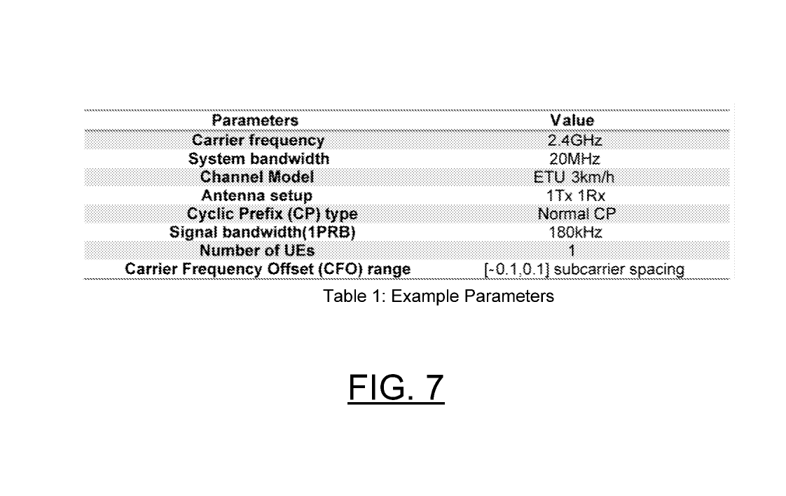

Referring now to FIG. 7, a table illustrating parameters for determining tracking performance of a communications system according to an example embodiment is provided. In the example embodiment of FIG. 7, the processor 24 of the eNB 12 (e.g., eNB 12) may utilize parameters of the table 1 to evaluate carrier offset frequency and timing tracking performance of a system (e.g., an LTE system) in an instance in which the eNB 12 determines that there are no free channels available in an unlicensed band (e.g., unlicensed band 18). For example, a coexisting system (e.g., a WiFi system, a WLAN system) may be using all of the channels of the unlicensed band. As such, the eNB 12 may transmit (e.g., a downlink communication) the ultra-low power wideband RS pattern 9 to a UE 14 via a channel currently being used/occupied by the coexisting system, as described above. The UE 14 may utilize the ultra-low power wideband RS pattern 9 to perform timing and tracking information.

As an example, to evaluate the CFO and timing tracking performance, the processor 24 of the eNB 12 may utilize the ultra-low power wideband RS pattern 9 and may deploy two UE implementations to evaluate the results. In this regard, an estimation over a half radio frame (Nₛ=10) may be considered and an estimation over a whole radio frame (Nₛ=20) may be considered. As described above, the required CFO accuracy is typically within 1% subcarrier spacing, which corresponds to a Mean Square Error MSE=10⁻⁴. The MSE may be evaluated by the processor 24 of the eNB 12 to determine a measurement of synchronization performance.

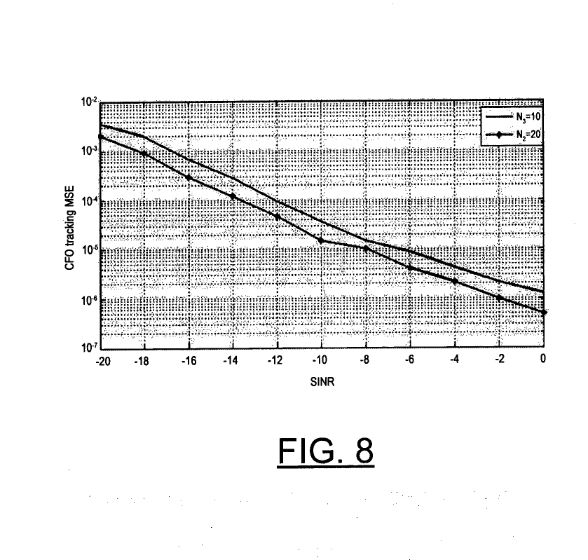

As shown in FIG. 8, it can be seen that the benchmark result MSE=10⁻⁴ is achieved at signal-to-interference ratio (SINR)=−12 dB (e.g., Nₛ=10) and −14 dB (e.g., for N_{S}=20), respectively. Consider an instance in which a coexisting system such as, for example, a WiFi system is operating at SNR=10 dB in a corresponding channel, then the eNB 12 may determine that the ultra-low power wideband RS pattern 9 has a very low power RS transmission, for example, at least −2 dB (e.g., 10 dB-12 dB) less than the white noise and −4 dB (e.g., 10 dB-14 dB) less than the white noise in another example embodiment. A low power RS transmission, for example, at least −2 dB and/or −4 dB less than the white noise (e.g., background noise) may be sufficient to perform CFO tracking. For example, since the power of the ultra-low power wideband RS pattern 9 is even lower than white noise, the ultra-low power wideband RS pattern 9 does not interfere with the coexisting system (e.g., WiFi system).

In addition, in order to satisfy the requirement for CFO accuracy being within 1% subcarrier spacing, corresponding to a Mean Square Error MSE=10⁻⁴, the power of the RS signal may satisfy:

noise_power/Hz*bandwidth+RS_power<wifi_detection_threshold

Presume as in the example above that the RS power is −2 dB less than the white noise power, in this regard the processor 24 of the eNB 12 may calculate:

noise_power/Hz*bandwidth+RS_power=−99 dBm

which is still much smaller than the WiFi detection threshold −82 dBm.

As such, the WiFi system may detect a noise of −99 dBm which is lower than the WiFi detection threshold of −82 dBm which may denote to the eNB 12 that in an instance in which the ultra-low power wideband RS pattern 9 is transmitted, the WiFi system may detect −99 dBm as background noise (e.g., white noise). As such, the WiFi system may not consider/determine that the corresponding channel is occupied by another communications system (e.g., an LTE communications system).

The calculations above demonstrates the that low power interference of the ultra-low power wideband RS pattern 9 may not cause a coexisting system such as, for example, a WiFi system to trigger a false alarm. In an instance in which a false alarm is triggered by the WiFi system, the WiFi system may have sensed/detected another system using a channel before the WiFi system starts transmission. In an instance in which the WiFi system determines that there is another system using the channel, the WiFi system may not use the channel. As such, in an instance in which the power of signals of another system (e.g., an LTE system) is too high, the power may cause the WiFi system to determine that the other system is using the corresponding channel. In this regard, the WiFi system may back off and not use the channel. However, as shown by the calculations above, in an instance in which the eNB 12 transmits ZC sequence based RS signals (e.g., ultra-low power wideband RS pattern 9) of an example embodiment, the WiFi system may not detect the signals since the power is below white noise (e.g., background noise). In this manner, the WiFi system may began transmissions since the WiFi system may not detect that the corresponding channel is being utilized by another system.

From a process delay perspective, with the configuration of the ultra-low power wideband RS pattern 9, the processor of the UE 14 may determine how many sequences Nₛ to accumulate to perform tracking. For example, based in part on the transmission power and the sequence bandwidth, the UE 14 may calculate the number of sequences N, required to achieve a satisfactory performance. The larger Nₛ, the better performance and longer process delay achieved.

Reference Signals may introduce interference to the WiFi system when the Reference Signal symbols collide with the WiFi transmissions. However, the SINK degradation caused by Reference Signal interference due to the ultra-low power wideband RS pattern transmission power may be insignificant. For instance, as described above in this example embodiment, the RS power is −2 dB or −4 dB lower than the white noise while the WiFi SNR is 10 dB, and as such the minimum degradation due to RS transmission of the ultra-low wideband RS pattern 9 may be only 1.4 dB loss. Moreover, this degradation may be further reduced as only a minimal part (or no part) of the WiFi transmission may be colliding with the RS signal due to the designated symbols gaps (e.g., the 5 gaps of the ultra-low power wideband RS pattern 9).

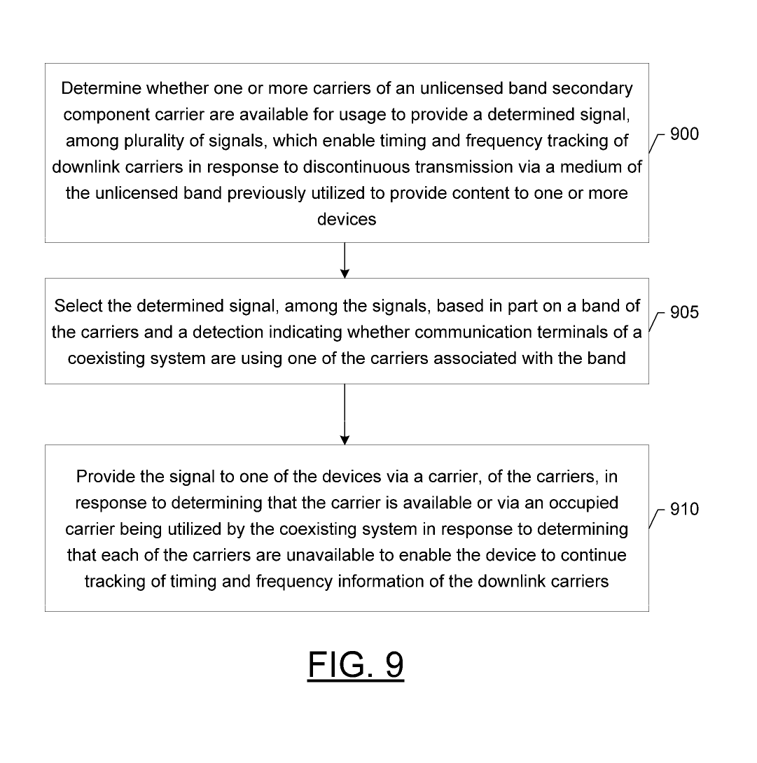

Referring now to FIG. 9, a flowchart for providing a reference signal via a carrier of an unlicensed band for performing downlink tracking according to an example embodiment is provided. At operation 900, an apparatus (e.g., eNB 12) may determine whether one or more carriers of an unlicensed band (e.g., unlicensed band 18) secondary component carrier are available for usage to provide at least one determined signal, among plurality of signals (e.g., a CRS, a ZC sequence based RS pattern 5, an ultra-low power wideband RS pattern 9), which enable timing and frequency tracking of one or more downlink carriers in response to discontinuous transmission via at least one medium of the unlicensed band previously utilized to provide content to one or more devices. At operation 905, an apparatus (e.g., eNB 12) may select the determined signal, among the signals, based in part on a band (e.g., a free wideband, a free narrowband, an occupied band) of the carriers and a detection indicating whether communication terminals (e.g., second terminals 16 (e.g., a WiFi station, a WLAN station, etc.)) of a coexisting system (e.g., a WiFi system, a WLAN system, etc.) are using at least one of the carriers associated with the band.

At operation 910, (e.g., an eNB 12) may provide the signal to at least one of the devices (e.g., a UE 14) via a carrier in response to determining that the carrier is available or via an occupied carrier being utilized by the coexisting system in response to determining that each of the carriers are unavailable to enable the device (e.g., UE 14) to continue tracking of timing and frequency information of the downlink carriers.

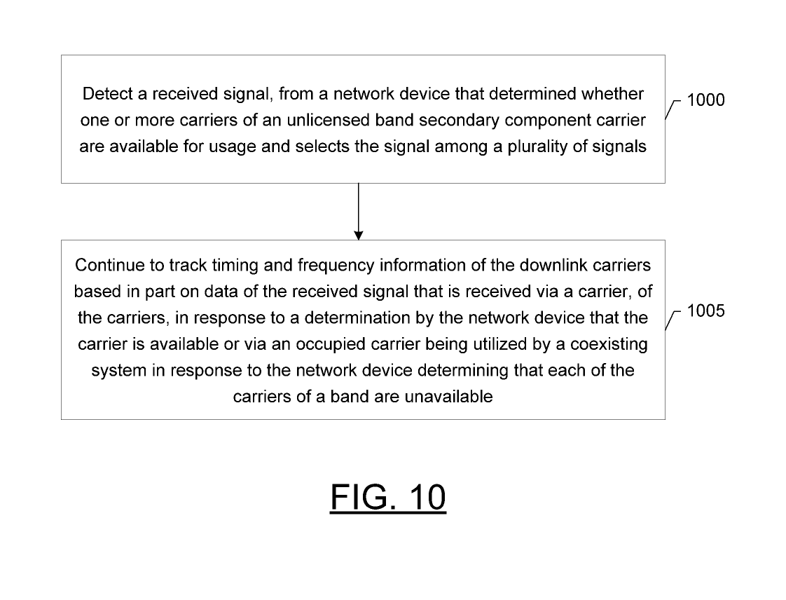

Referring now to FIG. 10, a flowchart for providing a reference signal via a carrier of an unlicensed band for performing downlink tracking according to another example embodiment is provided. At operation 1000, an apparatus (e.g., UE 14) may detect a received signal, from a network device (e.g., eNB 12) that determined whether one or more carriers of an unlicensed band secondary component carrier are available for usage. The network device may select the signal, among a plurality of signals (e.g., a CRS, a ZC sequence based RS pattern 5, an ultra-low power wideband RS pattern 9) based in part on a band of the carriers and a detection indicating whether communication terminals (e.g., second terminals 16 (e.g., a WiFi station, a WLAN station, etc.)) of a coexisting system (e.g., a WiFi system, a WLAN system) are using at least one of the carriers associated with the band. The signal enables timing and frequency tracking of one or more downlink carriers in response to discontinuous transmission via at least one medium of the unlicensed band previously utilized to receive content provided by the network device.

At operation 1005, an apparatus (e.g., UE 14) may continue to track timing and frequency information of the downlink carriers based in part on data of the received signal that is received via a carrier, of the carriers, in response to a determination by the network device (e.g., eNB 12) that the carrier (e.g., a free wideband, a free narrowband (e.g., a gap band)) is available or via an occupied carrier being utilized by a coexisting system in response to the network device determining that each of the carriers of a band are unavailable.

It should be pointed out that FIGS. 9 and 10 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory 26, memory 36) and executed by a processor (e.g., processor 24, processor 34). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 9 and 10 above may comprise a processor (e.g., the processor 24, the processor 34) configured to perform some or each of the operations (900-910, 1000-1005) described above. The processor may, for example, be configured to perform the operations (900-910, 1000-1005) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (900-910, 1000-1005) may comprise, for example, the processor 24 (e.g., as means for performing any of the operations described above), the processor 34 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining whether one or more component carriers of an unlicensed band secondary component carrier are available for usage to provide at least one determined signal, among a plurality of signals, which enable timing and frequency tracking of one or more downlink carriers in response to discontinuous transmission via at least one medium of the unlicensed band previously utilized to provide content to one or more devices;
selecting the determined signal, among the signals, based in part on a band of the component carriers and a detection indicating whether communication terminals of a coexisting system are using at least one of the component carriers associated with the band; and
enabling provision of the selected signal to at least one of the devices via a component carrier in response to determining that the component carrier is available or via another component carrier occupied in response to determining that each of the component carriers are unavailable to enable the device to continue tracking of timing and frequency information of the downlink carriers.

2. The method of claim 1, wherein selecting the determined signal comprises determining that the determined signal comprises a common reference signal generated in response to detecting that the coexisting system is not occupying the band, and the common reference signal comprises a fixed bandwidth and reference signal pattern.

3. (canceled)

4. The method of claim 1, wherein the selecting the determined signal comprises determining that the determined signal comprises a generated configurable reference signal comprising a plurality of Zadoff Chu sequences, each of the Zadoff Chu sequences are associated with a physical resource block or a plurality of physical resource blocks for transmission periodically over a set of symbols, and
wherein pairs of the Zadoff Chu sequences are separated by a gap of a subset of the symbols.

5. The method of claim 4, wherein the selecting of the determined signal is performed in response to determining that the band comprises a narrowband channel available for usage, wherein one or more adjacent bands of the narrowband channel are occupied by the coexisting system, and the narrowband channel comprises a gap band.

6. (canceled)

7. The method of claim 4, further comprising:
prior to the selecting the determined signal, assigning reference signal symbols of the signal to a center of the narrowband channel to minimize interference leakage to the adjacent bands,
wherein the enabling the provision comprises enabling the device to perform timing tracking based on the signal to maintain synchronization in time and frequency during the discontinuous time in which normal transmissions are turned off.

8. The method of claim 4, further comprising:
configuring or alternating the selected signal based in part on detected changes to conditions of component carriers of the unlicensed band; and
directing sending of the configured signal to the device to enable the device to continue tracking of timing and frequency information of the downlink carriers based in part on the configured signal.

9. The method of claim 8, wherein the configuring or alternating the selected signal comprises adjusting at least one of a bandwidth of the sequences, a power of at least one of the sequences and the symbols of the gap in part to minimize interference to the coexisting system.

10. The method of claim 4, further comprising:
estimating a carrier frequency offset by examining a phase shift between the plurality of Zadoff Chu sequences and determining whether the carrier frequency offset meets a requirement designated as acceptable based in part on comparison of the estimated carrier frequency to a predetermined value.

11. The method of claim 4, wherein the plurality of physical resource blocks are utilized to spread each of the sequences across a wide spectrum.

12. The method of claim 11, wherein the selecting of the determined signal is performed in response to determining that there are no free carriers among the component carriers of the band and are being occupied by the coexisting system.

13. The method of claim 12, wherein determining that there are no free carriers comprises determining that the component carriers of the band are unavailable based in part on being occupied by the coexisting system.

14. The method of claim 12, wherein prior to the selecting, the method comprises assigning the symbols of the gap to comprise a duration longer than a transmission duration of the coexisting system to avoid a collision with transmissions of the coexisting system.

15. The method of claim 13, wherein prior to enabling the provision, the method comprises:
determining that the selected signal comprising the plurality of Zadoff Chu sequences does not cause interference to the coexisting system, and
wherein the component carrier in which the selected, signal is provided to the device comprises an unavailable carrier being occupied by the coexisting system.

16. The method of claim 15, wherein determining that the selected signal comprising the plurality of Zadoff Chu sequences does not cause interference to the coexisting system in response to determining that the power of each of the sequences is below a background noise power which does not interfere with the coexisting system.

17-19. (canceled)

20. An apparatus comprising:
at least one processor; and
at least one memory including computer program code, wherein the at least one memory and the computer program code are configured to, with the at least one processor, cause the apparatus to at least:
determine whether one or more component carriers of an unlicensed band secondary component carrier are available for usage to provide at least one determined signal, among a plurality of signals, which enable timing and frequency tracking of one or more downlink carriers in response to discontinuous transmission via at least one medium of the unlicensed band previously utilized to provide content to one or more devices;
select the determined signal, among the signals, based in part on a hand of the component carriers and a detection indicating whether communication terminals of a coexisting system are using at least one of the carriers associated with the hand; and
enable provision of the selected signal to at least one of the devices via a component carrier in response to determining that the component carrier is available or via another carrier in response to determining that each of the component carriers are unavailable to enable the device to continue tracking of timing and frequency information of the downlink carriers.

21. The apparatus of claim 20, wherein the memory and the computer program code are configured to, with the processor, cause the apparatus to:
select the determined signal by determining that the determined signal comprises a common reference signal generated in response to detecting that the coexisting system is not occupying the band,
wherein the common reference signal comprises a fixed bandwidth and reference signal pattern.

22. (canceled)

23. The apparatus of claim 20, wherein the memory and the computer program code are configured to, with the processor, cause the apparatus to:
select the determined signal by determining that the determined signal comprises a generated configurable reference signal comprising a plurality of Zadoff Chu sequences, each of the Zadoff Chu sequences are associated with a physical resource block or a plurality of physical resource blocks for transmission periodically over a set of symbols, and
wherein pairs of the Zadoff Chu sequences are separated by a gap of a subset of the symbols.

24-47. (canceled)

48. An apparatus comprising:
at least one processor; and
at least one memory including computer program code, wherein the at least one memory and the computer program code are configured to, with the at least one processor, cause the apparatus to at least:
detect a received signal, from a network device that determined whether one or more component carriers of an unlicensed band secondary component carrier are available for usage by selecting the signal, among a plurality of signals, based in part on a band of the component carriers and a detection indicating whether communication terminals of a coexisting system are using at least one of the component carriers associated with the band, the signal enables timing and frequency tracking of one or more downlink carriers in response to discontinuous transmission via at least one medium of the unlicensed band previously utilized to receive content provided by the network device; and
continue to track timing and frequency information of the downlink carriers based in part on data of the received signal that is received via a component carrier, of the component carriers, in response to a determination by the network device that the component carrier is available or via an occupied carrier being utilized by a coexisting system in response to the network device determining that each of the component carriers of a band are unavailable.

49. The apparatus of claim 48, wherein:
the received signal comprises a common reference signal generated in response to a detection by the network device that the coexisting system is not occupying the band;
the common reference signal comprises a fixed bandwidth and reference signal pattern; and
the memory and the computer program code are configured to, with the processor, further cause to the apparatus to perform the tracking of the timing and frequency information based on data of the common reference signal.

50. (canceled)

51. The apparatus of claim 48, wherein the received signal comprises a configurable reference signal comprising a plurality of Zadoff Chu sequences, each of the Zadoff Chu sequences are associated with a physical resource block or a plurality of physical resource blocks for transmission periodically over a set of symbols, and
wherein pairs of the Zadoff Chu sequences are separated by a gap of a subset of the symbols.

52-57. (canceled)
